(19) United States
(12) Patent Application Publication
(10) Pub. No.: US 2020/0300029 A1
(43) Pub. Date: Sep. 24, 2020

(54) METHOD AND EQUIPMENT FOR PRODUCING A MULTIPLE-GLAZED UNIT

(71) Applicant: SAINT-GOBAIN GLASS FRANCE, COURBEVOIE (FR)

(72) Inventors: Sébastien HERVIEUX, CHOISY AU BAC (FR); Juergen OGUREK, GUNDELSHEIM (DE)

(21) Appl. No.: 16/089,821

(22) PCT Filed: Mar. 31, 2017
(86) PCT No.: PCT/FR2017/050764

§ 371 Date: Sep. 28, 2018

(30) Foreign Application Priority Data
Mar. 31, 2016 (FR) 1652797

(51) Int. Cl. E06B 3/673; E06B 3/663

(52) U.S. Cl. CPC E06B 3/6733; E06B 3/66366; E06B 3/66314; E06B 3/66352; E06B 3/66347; E06B 3/67369

(57) ABSTRACT

An insulating glazing includes two glass sheets spaced apart by an air- or gas-filled cavity, a spacer arranged at a periphery of the glass sheets and that keeps the glass sheets spaced apart, a transparent spacer made of transparent plastic and placed on at least one of the sides of the glazing, and a first leaktight barrier that is leaktight to water, formed by a structural seal, a material of which is watertight, and a second leaktight barrier that is leaktight to gases and to water vapor, the leaktight barriers being made of transparent material, wherein the spacer includes on at least one of its internal and external faces, the internal and external faces being respectively facing and on the opposite side from the gas-filled cavity, a coating which is thin and constitutes the second transparent barrier, the coating and the transparent spacer forming a single assembly.

The present invention relates to a process for manufacturing a multiple glazing unit comprising a spacer frame fastened between two glass sheets. The invention also relates to a plant for manufacturing multiple glazing units.

In a known manner, an insulating glazing unit (or multiple glazing unit) may be obtained by attaching at least one rigid spacer frame to the periphery of two glass sheets with the aid of sealing beads, and by applying an external sealing barrier over the entire outer perimeter of the spacer frame between the two glass sheets. The sealing beads between each glass sheet and the spacer frame, which are generally based on polyisobutylene (“butyl”), make it possible not only to pre-assemble the glass sheets with the spacer frame with a view to the sealing of the multiple glazing unit, but also to produce a primary barrier seal to water vapor and to gases. These sealing beads are conventionally deposited on either side of the spacer frame, on its side walls intended to be adjacent to the glass sheets of the multiple glazing unit, each glass sheet then being pressed against the corresponding side wall of the spacer frame level with the sealing bead.

The deposition of the sealing beads on the spacer frame should be carried out in a dedicated station, which is located outside of the main multiple glazing unit production line comprising the station for washing the glass sheets, the station for pressing the glass sheets against the spacer frame, the station for sealing the multiple glazing unit. During the pressing of the glass sheets against the spacer frame, the sealing beads previously deposited in the off-line station have had time to cool, which impairs the quality of the primary barrier seal. Furthermore, after the deposition of the sealing beads on the spacer frame, the latter is subjected to several manual or automated handling operations, which creates a risk of damaging the sealing beads located on either side of the spacer frame. The presence of defects in the sealing beads may here give rise to leaks of insulating gas present inside the multiple glazing unit, or else the entry of water vapor which condenses inside the multiple glazing unit, which impacts the quality and the durability of the multiple glazing unit. The deposition of the sealing beads should also be carried out after the assembling of the spacer frame, which necessitates carrying out the steps for manufacturing a multiple glazing unit successively, with a limited productivity.

It is these drawbacks that the invention more particularly intends to rectify by providing a process for manufacturing a multiple glazing unit that guarantees the obtaining of a good quality primary barrier seal, which is favorable for the durability of the multiple glazing unit, and which makes it possible to improve the cycle time and the productivity for the manufacture of multiple glazing units.

For this purpose, according to a first aspect, the invention relates to a process for manufacturing a multiple glazing unit comprising at least three glass sheets and a spacer frame fastened between two outer glass sheets, the or each central glass sheet of the multiple glazing unit being received in an internal peripheral groove of the spacer frame, each of the two outer glass sheets being connected to a side wall of the spacer frame by means of a sealing bead, characterized in that it comprises steps wherein:
for at least one of the two outer glass sheets, a sealing bead is deposited on a peripheral portion of a main face of the glass sheet;
the spacer frame is assembled around the central glass sheet(s);
   the or each outer glass sheet provided with its sealing bead is attached to a side wall of the spacer frame.

Of course, the order of the steps of the process according to the invention may be any technically possible order.

By means of the invention, as at least one sealing bead of the multiple glazing unit is deposited on a glass sheet rather than on the spacer frame, the risk of degradation of the sealing bead is limited. Specifically, the glass sheet, which is conventionally moved on a conveyor belt, is subjected to a few or no handling operations during the process for manufacturing the multiple glazing unit. Advantageously, as the deposition of the sealing bead on the glass sheet may be carried out on a main multiple glazing unit production line, upstream of a station for fitting the glass sheet to the spacer frame, the assembling of the glass sheet with the spacer frame may take place rapidly, while the sealing bead is still hot, which favors the quality of the primary barrier seal thus formed between the spacer frame and the glass sheet. In addition, with the process according to the invention, it is possible to carry out, at the same time in two separate stations, on the one hand the assembling of the spacer frame and on the other hand the deposition of a sealing bead on a glass sheet, hence a saving in cycle time and a gain in productivity for the manufacture of multiple glazing units can be achieved.

Within the context of the invention a “glass sheet” is understood to mean any type of transparent substrate suitable for use in a multiple glazing unit. It may be a sheet of mineral glass, in particular an oxide glass that may be a silicate, borate, sulfate, phosphate, or other. As a variant, it may be a sheet of organic glass, for example of polycarbonate or of polymethyl methacrylate.

According to a first embodiment of the invention, a sealing bead is deposited on a peripheral portion of a main face of each of the two outer glass sheets, and each outer glass sheet provided with its sealing bead is attached to a side wall of the spacer frame.

According to a second embodiment of the invention, a first sealing bead is deposited on a peripheral portion of a main face of a first outer glass sheet, which is intended to be connected to a first side wall of the spacer frame; a second sealing bead is deposited on a second side wall of the spacer frame opposite the first side wall of the spacer frame; the first outer glass sheet provided with its sealing bead is attached to the first side wall of the spacer frame; and the second outer glass sheet is attached to the second side wall of the spacer frame provided with its sealing bead.

In one embodiment, the multiple glazing unit comprises at least three glass sheets and a single spacer frame fastened between two outer glass sheets, the or each central glass sheet of the multiple glazing unit being received in an internal peripheral groove of the spacer frame. In this embodiment, a triple glazing unit thus comprises one spacer frame with one groove, two outer glass sheets being positioned on either side of the spacer frame and a central glass sheet being received in the groove of the spacer frame; a quadruple glazing unit comprises one spacer frame with two grooves, two outer glass sheets being positioned on either side of the spacer frame and two central glass sheets each being received in a respective groove of the spacer frame, etc.

Advantageously, the spacer frame is assembled around the central glass sheet(s) of the multiple glazing unit.

In particular, according to a first variant of assembling the spacer frame, the central glass sheet(s) of the multiple glazing unit is (are) inserted into an L-shaped or U-shaped open portion of the spacer frame, with their edges received in a respective groove, then the assembling of the spacer frame is finished by closing the L-shaped or U-shaped open portion around the central glass sheet(s) using one or two additional profiles that are fastened to the L-shaped or U-shaped portion.

According to a second variant of assembling the spacer frame, four profiles of the spacer frame are positioned on the four edges of the or each central glass sheet of the multiple glazing unit, by inserting the edges of each central glass sheet into the corresponding grooves of the profiles, then the profiles are fastened in twos at their ends in the corners of the spacer frame.

According to one feature, in the embodiment with a spacer frame having (a) groove(s), each groove of the spacer frame is provided with a liner for receiving a central glass sheet, in particular based on elastomer material such as ethylene-propylene-diene rubber (EPDM). The groove may have a width greater than the thickness of the central glass sheet. The liner is used to fasten the central glass sheet in the groove, while making it possible to compensate for possible thermal expansion variations of the central glass sheet. A stress-free fastening of the central glass sheet in the groove is thus ensured. Advantageously, the reduction of the stresses applied to the central glass sheet makes it possible to reduce the thickness and the weight of this central glass sheet, relative to those used in multiple glazing units where the central glass sheet is fastened to the periphery of a spacer frame instead of being received in a groove. The liner is advantageously configured to enable a balancing by circulation of gas between the cavities of the multiple glazing unit located on either side of the central glass sheet.

In the case of a multiple glazing unit comprising at least one spacer frame fastened between first and second glass sheets, where each of the first and second glass sheets is connected to a side wall of the spacer frame by means of a sealing bead, the manufacture of the multiple glazing unit may involve the deposition of a sealing bead on a peripheral portion of a main face of at least one of the first and second glass sheets, and the attachment of the or each glass sheet provided with its sealing bead to a side wall of the spacer frame.

More specifically, according to a second aspect, the invention relates to a process for manufacturing a multiple glazing unit comprising at least one spacer frame fastened between first and second glass sheets, each of the first and second glass sheets being connected to a side wall of the spacer frame by means of a sealing bead, the process comprising steps wherein:
a sealing bead is deposited on a peripheral portion of a main face of the first glass sheet, which is intended to be connected to a first side wall of the spacer frame;
a sealing bead is deposited on a second side wall of the spacer frame opposite the first side wall of the spacer frame;
the first glass sheet provided with its sealing bead is attached to the first side wall of the spacer frame;
the second glass sheet is attached to the second side wall of the spacer frame provided with its sealing bead.

Of course, the order of the steps of the process according to the invention may be any technically possible order.

Owing to the asymmetry for the deposition of the sealing beads, one being deposited on a glass sheet whereas the other is deposited on the spacer frame, it is possible to assemble each glass sheet with the spacer frame rapidly after the deposition of the corresponding sealing bead, when the sealing bead is still hot, which favors the quality of the primary barrier seal thus formed between the spacer frame and the glass sheet. In particular, the attachment of the second glass sheet to the second side wall of the spacer frame is advantageously carried out directly after the deposition of the sealing bead on the second side wall of the spacer frame, while the attachment of the first glass sheet to the first side wall of the spacer frame is advantageously carried out directly after the deposition of the sealing bead on the first glass sheet. Furthermore, here too, owing to the process according to the invention, it is possible to carry out, at the same time in two separate stations, on the one hand the assembling of the spacer frame and on the other hand the deposition of a sealing bead on a glass sheet, hence a saving in cycle time and a gain in productivity for the manufacture of multiple glazing units can be achieved.

In one particular embodiment, the multiple glazing unit comprises at least three glass sheets and, for each pair of adjacent glass sheets, a spacer frame is fastened between the two glass sheets of the pair. In this embodiment, a triple glazing unit thus comprises two spacer frames each fastened between two adjacent glass sheets of the three glass sheets of the glazing unit; a quadruple glazing unit comprises three spacer frames each fastened between two adjacent glass sheets of the four glass sheets of the glazing unit; etc.

Advantageously, within the context of a process according to the invention, the assembling of the spacer frame of the multiple glazing unit and the deposition of a sealing bead on at least one glass sheet of the multiple glazing unit may take place simultaneously in two separate stations.

According to one advantageous implementation of the invention, each sealing bead is based on a resin selected from polyisobutylene (butyl); a hot-melt adhesive (hot-melt butyl); an acrylic or rubber- or silicone-modified acrylic double-sided adhesive tape, more commonly known by the name “double-sided sealing tape of pressure-sensitive adhesive (PSA) type”; an adhesive of acrylic or epoxy type, optionally crosslinkable under the action of ultraviolet radiation. These resins have good performances in terms of impermeability to water vapor and to gases, and also a good adhesion to the glass, while withstanding ozone, oxygen and ultraviolet radiation.

Preferably, each sealing bead is based on polyisobutylene (butyl). Butyl is particularly efficient in terms of impermeability to water vapor and to gases. However, its mechanical performance is insufficient to hold the glass sheets together and against the spacer frame. The glass sheets are then held by an external sealing barrier, which is applied over the entire outer perimeter of the spacer frame between the glass sheets. The external sealing barrier may be formed, in particular, from a resin chosen from polysulfides, polyurethanes, silicones, hot-melt butyls, and combinations or mixtures thereof. These sealing products have a good adhesion to the glass sheets and mechanical properties that enable them to ensure that the glass components are held against the spacer frame.

According to one feature of the invention, for each glass sheet intended to be provided with a sealing bead, the sealing bead is deposited on a peripheral portion of a main face of the glass sheet by extrusion. The technique of depositing a resin by extrusion on the periphery of a main face of a glass sheet is used in fields other than the manufacture of multiple glazing units, in particular in the field of the manufacture of glazing units for vehicles comprising a peripheral seal that is intended to ensure the connection between the glazing unit and the body of the vehicle. A station for depositing a sealing bead by extrusion on a peripheral portion of a main face of a glass sheet may consequently be easily installed in a multiple glazing unit production line, without generating additional design costs, since suitable equipment has already been developed for vehicle glazing unit production lines.

According to one feature of the invention, each of the first and second glass sheets is attached to a side wall of the spacer frame by pressing. Advantageously, the pressing of the glass sheet(s) provided with its (their) sealing beads may take place in a conventional multiple glazing unit pressing device, without modification of the existing production lines.

Advantageously, the spacer frame, whether it is a spacer frame with or without groove(s), defines a housing for receiving desiccant material. Preferably, the spacer frame comprises desiccant material in at least two of its sides, in order to ensure a dehydration of each cavity formed between the glass sheets of the multiple glazing unit. An inner transverse wall of each side of the spacer frame having desiccant material in its internal volume is provided with a plurality of perforations, so as to place the desiccant material in communication with the internal air or gas of the corresponding cavity. The desiccant material may thus absorb the moisture within the cavity and prevent the formation of condensation between the glass sheets of the multiple glazing unit. The desiccant material may be any material capable of ensuring a dehydration of the air or the gas space present in each cavity of the multiple glazing unit, in particular chosen from a molecular sieve, silica gel, CaCl₂, Na₂SO₄, activated carbon, zeolites, and/or a mixture thereof.

Each cavity of the multiple glazing unit between the glass sheets may be filled with air. However, preferably, each cavity of the multiple glazing unit comprises a space filled with an insulating gas, which replaces the air between the glass sheets. Examples of gases used to form the insulating gas space in each cavity of the multiple glazing unit comprise, in particular, argon (Ar), krypton (Kr), xenon (Xe). Advantageously, the insulating gas space in each cavity of the multiple glazing unit comprises at least 85% of a gas having a thermal conductivity lower than that of air. Suitable gases are preferably colorless, nontoxic, noncorrosive, nonflammable, and insensitive to exposure to ultraviolet radiation.

According to the invention, the spacer frame may be formed of metal and/or of polymer material. Examples of suitable metal materials include, in particular, aluminum or stainless steel. Examples of suitable polymer materials include, in particular, polyethylene (PE), polycarbonate (PC), polypropylene (PP), polystyrene, polybutadiene, polyesters, polyurethanes, polymethyl methacrylate, polyacrylates, polyamides, polyethylene terephthalate (PET), polybutylene terephthalate (PBT), acrylonitrile-butadiene-styrene (ABS), acrylonitrile-styrene-acrylate (ASA), styrene-acrylonitrile copolymer (SAN). Any combination or mixture of these materials can also be envisaged, for example each profile of the spacer frame may be based on polypropylene comprising a reinforcement formed by a stainless steel film. When it is based on polymer material, the profile is advantageously reinforced by fibers, in particular glass or carbon fibers.

According to one implementation of the invention, each glass sheet of the multiple glazing unit is moved through several successive work stations while being substantially vertical. In particular, each glass sheet may be moved through the successive work stations using a conveyor belt.

According to one feature of the invention, at least one glass sheet, which is intended to be connected to a side wall of a spacer frame of the multiple glazing unit, passes through several successive stations that comprise at least, from upstream to downstream:
a station for washing the glass sheet;
a station for depositing a sealing bead on a peripheral portion of a main face of the glass sheet;
a station for fitting the glass sheet to the spacer frame.

In one embodiment, prior to passing through the station for fitting the glass sheet to the spacer frame, the glass sheet passes through a station for turning the glass sheet through 180° upon itself so as to reverse the direction of its main faces.

Advantageously, during a cycle of manufacturing a multiple glazing unit according to the process of the invention, the various glass sheets of the multiple glazing unit are received simultaneously in various work stations that are located upstream of a single station for fitting glass sheets to the spacer frame. This makes it possible to reduce the cycle time and to increase the productivity, in particular for the manufacture of multiple glazing units containing at least three glass sheets.

According to a third aspect, the invention relates to a plant for manufacturing multiple glazing units comprising at least one spacer frame fastened between two glass sheets, this plant comprising, at the same time, on the one hand a station for assembling a spacer frame, and on the other hand a station for depositing a sealing bead on a peripheral portion of a main face of a glass sheet, so that the assembling of the spacer frame of a multiple glazing unit and the deposition of a sealing bead on at least one glass sheet of the same multiple glazing unit may take place simultaneously in the assembling station and in the bead deposition station.

When the plant is intended for the manufacture of multiple glazing units comprising at least three glass sheets and a spacer frame fastened between two outer glass sheets, with the or each central glass sheet of the multiple glazing unit which is received in an internal peripheral groove of the spacer frame:
the assembling station is advantageously configured to ensure an assembling of the spacer frame around the central glass sheet(s),
the bead deposition station is advantageously configured to ensure a deposition of a sealing bead on a peripheral portion of a main face of at least one of the two outer glass sheets.

According to one feature, the plant comprises a main line with several successive stations that comprise at least, from upstream to downstream:
a station for washing glass sheets;
the station for depositing a sealing bead on a peripheral portion of a main face of a glass sheet;
a station for fitting glass sheets to a spacer frame.

In one embodiment, the main line comprises, between the station for depositing a sealing bead on a glass sheet and the station for fitting glass sheets to a spacer frame, a station for turning a glass sheet through 180° upon itself so as to reverse the direction of its main faces.

Advantageously, the main line comprises, downstream of the station for fitting glass sheets to a spacer frame, a station for sealing a multiple glazing unit at the outer periphery of the or each spacer frame between the glass sheets.

According to one feature of the invention, the plant comprises a conveyor belt for moving the glass sheets through the successive stations of the main line.

In one embodiment, the station for assembling a spacer frame, and an optional station for depositing a sealing bead on a side wall of a spacer frame, are located outside of the main line and upstream of the station for fitting glass sheets to a spacer frame.

The features and advantages of the invention will become apparent in the following description of several embodiments of a process and of a plant for manufacturing multiple glazing units according to the invention, given solely by way of example and with reference to the appended drawings, in which:

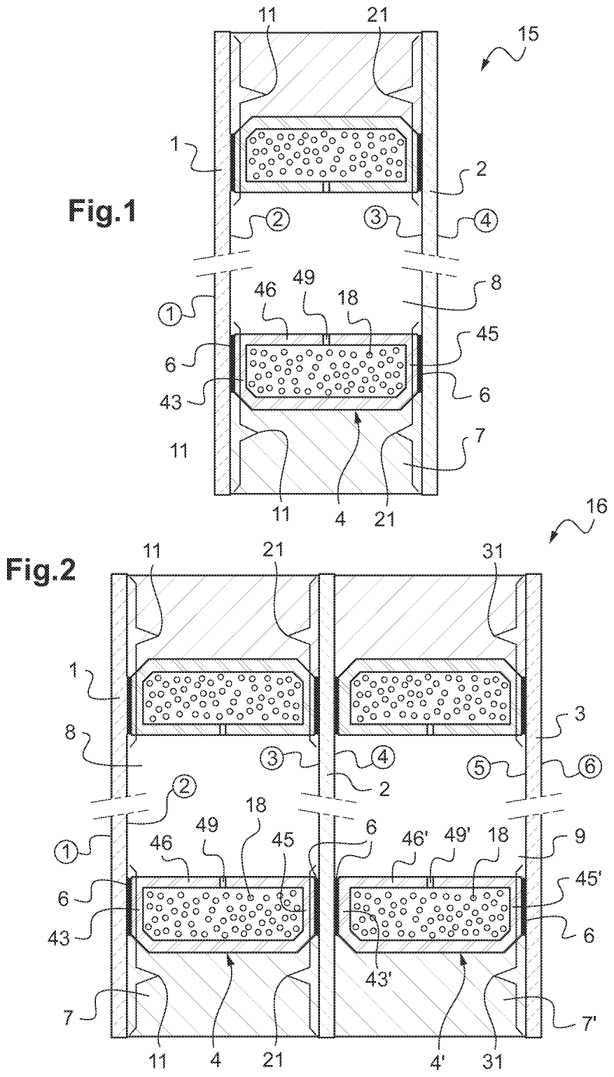

FIG. 1 is a partial cross section of a double glazing unit comprising two glass sheets and a spacer frame;

FIG. 2 is a cross section similar to FIG. 1 for a triple glazing unit comprising three glass sheets and two spacer frames;

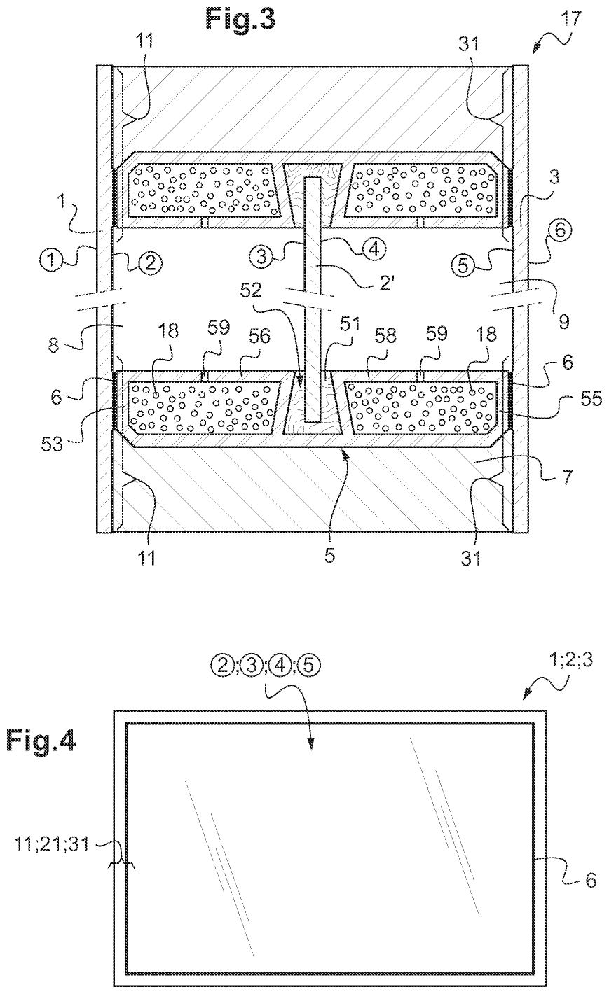

FIG. 3 is a cross section similar to FIG. 1 for a triple glazing unit comprising three glass sheets and a grooved spacer frame;

FIG. 4 is a schematic view of a main face of at least one glass sheet of the multiple glazing units of FIGS. 1 to 3 which is intended to be connected to a side wall of a spacer frame, before the assembly thereof with the spacer frame;

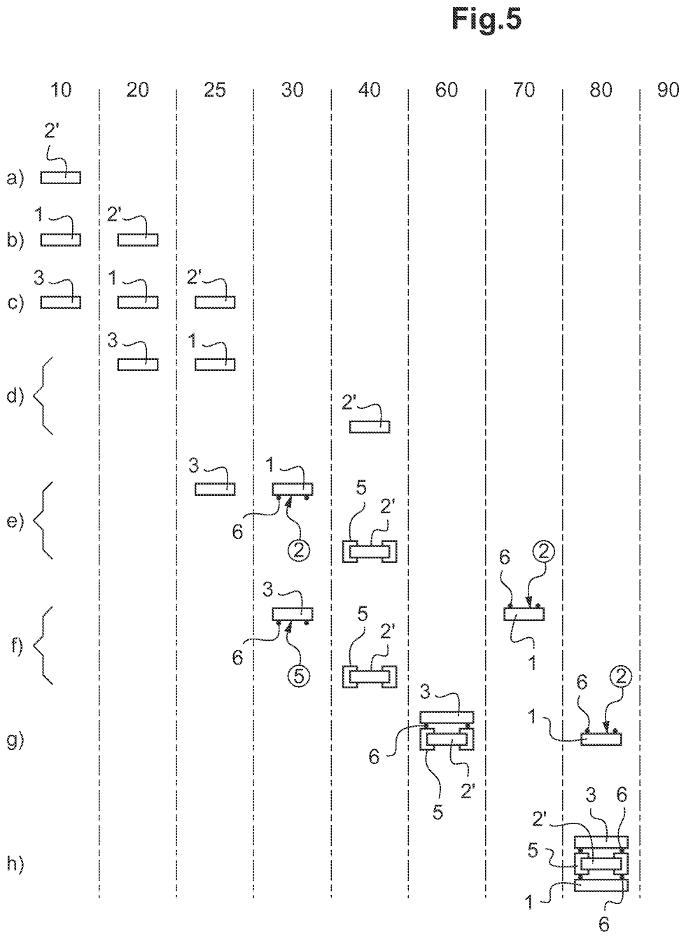

FIG. 5 is a schematic representation of the successive steps of a sequence of a process for manufacturing a triple glazing unit in accordance with a first embodiment of the invention;

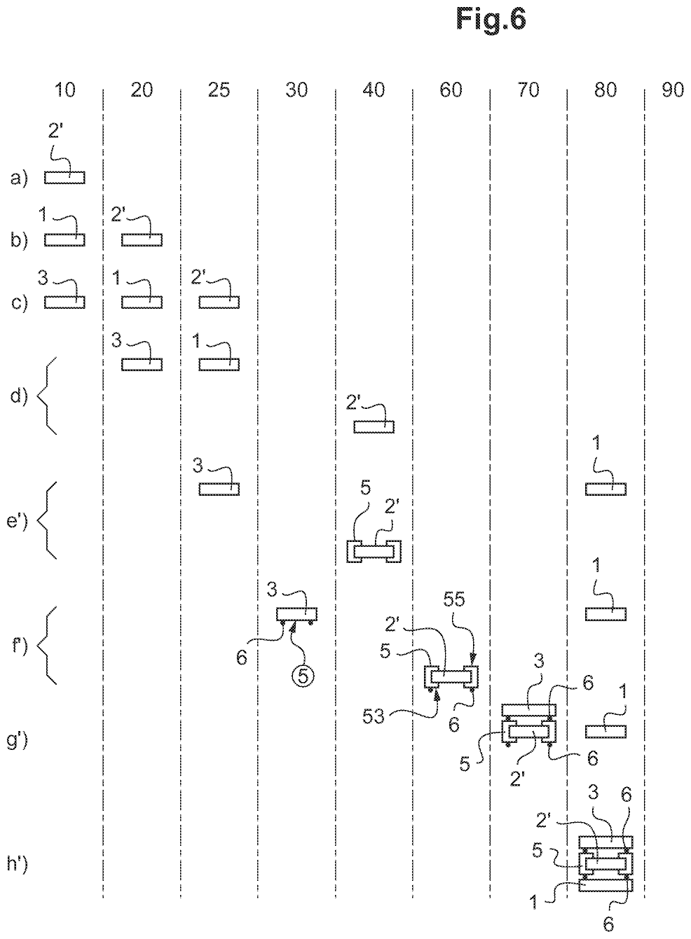

FIG. 6 is a schematic representation of the successive steps of a sequence of a process for manufacturing a triple glazing unit in accordance with a second embodiment of the invention.

The process according to the invention makes it possible to obtain multiple glazing units having any number, greater than or equal to two, of glass sheets. The invention is thus applicable for the manufacture of double glazing units, triple glazing units, quadruple glazing units, etc.

It is customary to name the various main faces of the glass sheets of a multiple glazing unit by numbers starting from \textcircled{1}, the number \textcircled{1} denoting the outer face of the glass sheet intended to be turned toward the outside of a building.

Thus, for a double glazing unit (FIG. 1), the outer face of the glass sheet 1 intended to be turned toward the outside of a building bears the number \textcircled{1}, the inner face of the glass sheet 1 intended to be turned toward the outside of a building bears the number \textcircled{2}, the outer face of the glass sheet 2 intended to be turned toward the inside of a building bears the number \textcircled{3}, the inner face of the glass sheet 2 intended to be turned toward the inside of a building bears the number \textcircled{4}.

Similarly, for a triple glazing unit (FIGS. 2 and 3), the outer face of the outer glass sheet 1 intended to be turned toward the outside of a building bears the number \textcircled{1}, the inner face of the outer glass sheet 1 intended to be turned toward the outside of a building bears the number \textcircled{2}, the face of the inner glass sheet 2 turned toward the outer glass sheet 1 bears the number \textcircled{3}, the face of the inner glass sheet 2 turned toward the outer glass sheet 3 bears the number \textcircled{4}, the inner face of the outer glass sheet 3 intended to be turned toward the inside of a building bears the number \textcircled{5}, the outer face of the outer glass sheet 3 intended to be turned toward the inside of a building bears the number \textcircled{6}.

FIGS. 1 to 3 show examples of multiple glazing units obtained by the process according to the invention.

The double glazing unit 15 represented in FIG. 1 comprises two glass sheets 1, 2 parallel to one another, which are positioned opposite one another. The two glass sheets 1, 2 may have different thicknesses. The dimensions (surface area, thicknesses of the glass sheets) should be chosen as a function of the desired application of the double glazing unit.

The double glazing unit 15 also comprises a spacer frame 4, which is fastened between the two glass sheets 1, 2 so as to keep the glass sheets 1, 2 at a distance from one another while forming a cavity 8. The cavity 8 is filled with insulating gas, which gives good thermal and acoustic insulation to the double glazing unit 15. As is clearly visible in FIG. 1, the spacer frame 4 is located between the main faces \textcircled{2} and \textcircled{3}, located opposite one another, of the two glass sheets 1, 2, in a peripheral portion 11 or 21 of the opposite faces of the two glass sheets.

Each of the glass sheets 1, 2 is connected to a side wall 43 or 45 of the spacer frame 4 by means of a butyl sealing bead 6. The double glazing unit 15 also comprises an external sealing barrier 7 made of polysulfide resin, which is applied over the entire outer perimeter of the spacer frame 4 between the two glass sheets 1, 2, so as to hold the glass sheets 1, 2 together and against the spacer frame 4.

According to the invention, the double glazing unit 15 is obtained by depositing a sealing bead 6 on the peripheral portion 11 or 21 of the main face \textcircled{2} or \textcircled{3} of a first sheet from among the two glass sheets 1, 2 according to the configuration shown in FIG. 4; deposition of a sealing bead 6 on the side wall 43 or 45 of the spacer frame which is not intended to cooperate with the first glass sheet provided with the sealing bead 6; attachment, by pressing, of the first glass sheet provided with its sealing bead 6 to the corresponding side wall 45 or 43 of the spacer frame which has no sealing bead; attachment, by pressing, of the second glass sheet from among the two glass sheets 1, 2 to the corresponding side wall of the spacer frame provided with its sealing bead 6.

Advantageously, the asymmetry for the deposition of the sealing beads 6, one being deposited on the first glass sheet whereas the other is deposited on the spacer frame, makes it possible to assemble each of the two glass sheets 1, 2 with the spacer frame 4 rapidly after the deposition of the corresponding sealing bead, while the sealing bead is still hot. Preferably, the attachment between the first glass sheet provided with a sealing bead 6 and the corresponding side wall of the spacer frame 4 with no sealing bead is carried out rapidly after the deposition of the sealing bead 6 on the first glass sheet, and the attachment between the second glass sheet with no sealing bead and the side wall of the spacer frame 4 provided with a sealing bead 6 is carried out rapidly after the deposition of the sealing bead 6 on the spacer frame.

The triple glazing unit 16 represented in FIG. 2 comprises three glass sheets 1, 2, 3 parallel to one another, which are positioned opposite one another. One of the glass sheets, referred to as the central glass sheet 2, is located between the two other glass sheets, referred to as outer glass sheets 1, 3. The three glass sheets 1, 2, 3 may have different thicknesses. The dimensions (surface area, thicknesses of the glass sheets) should be chosen as a function of the desired application of the triple glazing unit.

The triple glazing unit 16 also comprises two spacer frames 4, 4′, which are each fastened between two glass sheets, respectively the glass sheets 1, 2 and the glass sheets 2, 3, so as to keep them at a distance from one another while forming two cavities 8, 9. The cavities 8, 9 are each filled with insulating gas, which gives good thermal and acoustic insulation to the triple glazing unit 16. The two cavities 8, 9 may have the same thickness or have different thicknesses, depending on the desired application of the triple glazing unit. Each spacer 4, 4′ is located between two main faces, located opposite one another, of the two glass sheets that flank it, in a peripheral portion 11, 21 or 31 of the opposite faces of the two glass sheets. Thus, the spacer frame 4 is located between the main faces \textcircled{2} and \textcircled{3} of the glass sheets 1, 2, while the spacer frame 4′ is located between the main faces \textcircled{4} and \textcircled{5} of the glass sheets 2, 3.

Each of the two glass sheets 1, 2 is connected to a side wall 43 or 45 of the spacer frame 4 by means of a butyl sealing bead 6. Similarly, each of the two glass sheets 2, 3 is connected to a side wall 43′ or 45′ of the spacer frame 4′ by means of a butyl sealing bead 6. The triple glazing unit 16 also comprises, for holding the glass sheets 1, 2, 3 together and against the spacer frames 4, 4′, an external sealing barrier 7, 7′ made of polysulfide resin applied respectively over the entire outer perimeter of the spacer frame 4 between the two glass sheets 1, 2 and over the entire outer perimeter of the spacer frame 4′ between the two glass sheets 2, 3.

According to the invention, the triple glazing unit 16 is obtained by depositing a sealing bead 6 on the peripheral portion 11, 21 or 31 of only some main faces \textcircled{2}, \textcircled{3}, \textcircled{4}, \textcircled{5} of the glass sheets 1, 2, 3 according to the configuration shown in FIG. 4;

deposition of a sealing bead 6 on the side walls of the spacer frames 4, 4′ which are not intended to cooperate with the main faces of the glass sheets provided with a sealing bead 6; attachment, by pressing, of the main faces of the glass sheets 1, 2, 3 provided with a sealing bead 6 to the corresponding side walls of the spacer frames 4, 4′ which have no sealing bead; attachment, by pressing, of the main faces of the glass sheets 1, 2, 3 with no sealing bead to the corresponding side walls of the spacer frames 4, 4′ which are provided with a sealing bead 6.

As above, the asymmetry for the deposition of the sealing beads 6 makes it possible to assemble each of the two glass sheets with the spacer frame 4, 4′ rapidly after the deposition of the corresponding sealing bead, while the sealing bead is still hot.

The triple glazing unit 17 represented in FIG. 3 comprises three glass sheets 1, 2′, 3 parallel to one another, which are positioned opposite one another. One of the glass sheets, referred to as the central glass sheet 2′, is located between the two other glass sheets, referred to as outer glass sheets 1, 3. The central glass sheet 2′ has a surface area smaller than those of the two outer glass sheets 1, 3. The three glass sheets 1, 2′, 3 may have different thicknesses, in particular the central glass sheet 2′ may have a thickness thinner than those of the two outer glass sheets 1, 3. The dimensions (surface area, thicknesses of the glass sheets) should be chosen as a function of the desired application of the triple glazing unit.

The triple glazing unit 17 also comprises a single spacer frame 5, which is fastened between the two outer glass sheets 1, 3, while the central glass sheet 2′ is received in an internal peripheral groove 52 of the spacer frame 5, with insertion of an EPDM liner 51 that is positioned in the groove 52 for receiving the edge of the central glass sheet 2′. The glass sheets 1, 2′, 3 are thus held at a distance from one another while forming two cavities 8, 9. The cavities 8, 9 are each filled with insulating gas, which gives good thermal and acoustic insulation to the triple glazing unit 17. The two cavities 8, 9 may have the same thickness or have different thicknesses, depending on the desired application of the triple glazing unit. As is clearly visible in FIG. 3, the spacer frame 5 is located between the main faces \textcircled{2} and \textcircled{5}, located opposite one another, of the two glass sheets 1, 3, in a peripheral portion 11 or 31 of the opposite faces of the two glass sheets 1, 3.

Each of the two glass sheets 1, 3 is connected to a side wall 53 or 55 of the spacer frame 5 by means of a butyl sealing bead 6. The triple glazing unit 17 also comprises an external sealing barrier 7 made of polysulfide resin, which is applied over the entire outer perimeter of the spacer frame 5 between the two outer glass sheets 1, 3, so as to hold the glass sheets 1, 3 together and against the spacer frame 5.

According to one embodiment of the invention, the triple glazing unit 17 is obtained by assembling the spacer frame 5 around the central glass sheet 2′; deposition of a sealing bead 6 on the peripheral portion 11, 31 of the main face \textcircled{2}, \textcircled{5} of each of the two outer glass sheets 1, 3 according to the configuration shown in FIG. 4; attachment, by pressing, of each outer glass sheet 1, 3 provided with its sealing bead 6 to the corresponding side wall 53, 55 of the spacer frame 5.

According to another embodiment of the invention, the triple glazing unit 17 is obtained by assembling the spacer frame 5 around the central glass sheet 2′; deposition of a sealing bead 6 on the peripheral portion 11 or 31 of the main face \textcircled{2} or \textcircled{5} of a first sheet from among the two outer glass sheets 1, 3 according to the configuration shown in FIG. 4; deposition of a sealing bead 6 on the side wall 53 or 55 of the spacer frame 5 which is not intended to cooperate with the first glass sheet provided with the sealing bead 6; attachment, by pressing, of the first glass sheet provided with its sealing bead 6 to the corresponding side wall 55 or 53 of the spacer frame which has no sealing bead; attachment, by pressing, of the second sheet from among the two outer glass sheets 1, 3 to the corresponding side wall of the spacer frame 5 provided with its sealing bead 6.

Preferably, in the examples from FIGS. 1 to 3, the assembling of the spacer frame of the multiple glazing unit 15, 16, 17 and the deposition of a sealing bead 6 on at least one glass sheet of the multiple glazing unit take place simultaneously in two separate stations.

In each of the examples from FIGS. 1 to 3, each spacer frame 4, 4′, 5 defines at least one housing for receiving desiccant material 18 that may be, for example, a molecular sieve or silica gel. The inner transverse walls 46, 46′, 56 and 58 of each spacer frame 4, 4′, 5 are provided with a plurality of perforations 49, 49′, 59, so that the desiccant material 18 is capable of absorbing the moisture within each cavity 8, 9 of the multiple glazing unit, which makes it possible to prevent the formation of condensation between the glass sheets.

As nonlimiting examples, two embodiments of a process and of a plant for manufacturing triple glazing units 17 as described above are illustrated schematically in FIGS. 5 and 6. Each of FIGS. 5 and 6 shows the successive steps of a sequence for manufacturing a triple glazing unit 17.

In the first embodiment represented in FIG. 5, in a step a), the central glass sheet 2′ is in a glass sheet store 10 located at an upstream end of a main line of the plant for manufacturing triple glazing units. The glass sheets are moved through the successive work stations of the main line using a conveyor belt (not represented), while each being in a substantially vertical position.

In a step b), the central glass sheet 2′ is in a glass sheet washing station 20 located on the main line, whereas the outer glass sheet 1 is in the store 10.

In a step c), the central glass sheet 2′ is in a glass sheet inspection station 25 located on the main line, where it is checked that the glass sheet does not have defects or impurities. The outer glass sheet 1 is then in the washing station 20 while the outer glass sheet 3 is in the store 10.

In a step d), the central glass sheet 2′ is in a station 40 for assembling the spacer frame 5 around the central glass sheet 2′. This spacer frame assembly station 40 is located outside of the main line and parallel thereto. As mentioned previously, the assembling of the spacer frame 5 around the central glass sheet 2′ may be obtained in the station 40 by inserting the central glass sheet 2′ into an L-shaped or U-shaped open portion of the spacer frame, then by closing the L-shaped or U-shaped portion around the central glass sheet 2′ using one or two additional profiles that are fastened to the L-shaped or U-shaped portion. As a variant, the assembling of the spacer frame 5 around the central glass sheet 2′ may be obtained in the station 40 by positioning the four profiles of the spacer frame on the four edges of the central glass sheet 2′, then by fastening the profiles in twos at their ends in the corners of the spacer frame. In this step d), the outer glass sheet 1 is in the inspection station 25, while the outer glass sheet 3 is in the washing station 20.

In a step e), the outer glass sheet 1 is in a glass sheet butyl-coating station 30 located on the main line, in which station a butyl sealing bead 6 is deposited by extrusion on the peripheral portion 11 of its main face \textcircled{2}, according to the configuration shown in FIG. 4. The outer glass sheet 3 is then in the inspection station 25, and the central glass sheet 2′ is still in the spacer frame assembly station 40 located outside of the main line.

In a step f), the outer glass sheet 1 is in glass sheet turning station 70 located in the main line, downstream of the spacer frame assembly station 40. The positioning of the station 40 outside of the main line enables the outer glass sheets 1, 3 to advance through the stations of the main line without being blocked by the step of assembling the spacer frame 5 around the central glass sheet 2′, which is a relatively long step. In the turning station 70, the outer glass sheet 1 is pivoted through 180° upon itself so as to reverse the direction of its main faces \textcircled{1} and \textcircled{2}, and to have the main face \textcircled{2} provided with the sealing bead 6 the opposite way from the direction that it had in the butyl-coating station 30. The outer glass sheet 3 is then in the butyl-coating station 30, in which a butyl sealing bead 6 is deposited by extrusion on the peripheral portion 31 of its main face \textcircled{5}, according to the configuration shown in FIG. 4. In this step f), the central glass sheet 2′ is still in the spacer frame assembly station 40 located outside of the main line.

In a step g), the outer glass sheet 1 is placed on hold in a press 80 intended for fitting the outer glass sheets 1, 3 to the spacer frame 5, with its main face \textcircled{2} provided with the sealing bead 6 oriented the opposite way from the direction that it had in the butyl-coating station 30. The outer glass sheet 3 is then in a spacer frame pre-fitting station 60, which is located on the main line, with its main face \textcircled{5} provided with the sealing bead 6 still oriented in the direction that it had in the butyl-coating station 30. In the pre-fitting station 60, the outer glass sheet 3 is attached to the spacer frame 5 by pre-pressing of its main face \textcircled{5} provided with the sealing bead 6 against the side wall 55 of the spacer frame, which is assembled around the central glass sheet 2′.

In a step h), the pre-pressed assembly comprising the outer glass sheet 3 and the spacer frame 5, itself assembled around the central glass sheet 2′, passes into the press 80 where the outer glass sheet 1 is attached to the spacer frame 5 by pressing of its main face \textcircled{2} provided with the sealing bead 6 against the side wall 53 of the spacer frame, and the two outer glass sheets 1, 3 are pressed on either side of the spacer frame 5. The filling of the cavities 8 and 9 may also take place in the press 80.

In a subsequent step not represented in detail, the triple glazing unit passes into a station 90 for sealing the triple glazing unit at the outer periphery of the spacer frame 5, in which an external sealing barrier 7 made of polysulfide resin is applied over the entire outer perimeter of the spacer frame 5 between the outer glass sheets 1, 3, so as to hold the outer glass sheets 1, 3 of the triple glazing unit 17 together and against the spacer frame.

In the second embodiment represented in FIG. 6, the components analogous to those of the first embodiment bear identical references. This second embodiment differs from the first embodiment in that the glass sheet turning station 70 located on the main line is removed, and in that a station 50 for butyl coating a wall of a spacer frame is added at the outlet of the spacer frame assembly station 40, while being located outside of the main line.

In the second embodiment, steps a) to d) are identical to those described above.

In a step e′), the outer glass sheet 1 passes directly from the inspection station 25 to the press 80, without stopping in the glass sheet butyl-coating station 30. The outer glass sheet 3 is then in the washing station 20, and the central glass sheet 2′ is in the spacer frame assembly station 40 located outside of the main line.

In a step f′), the outer glass sheet 1 is placed on hold in the press 80. The outer glass sheet 3 is then in the glass sheet butyl-coating station 30, in which a butyl sealing bead 6 is deposited by extrusion on the peripheral portion 31 of its main face \textcircled{5}, according to the configuration shown in FIG. 4. In this step f′), the spacer frame 5 assembled around the central glass sheet 2′ is in the spacer frame butyl-coating station 50 located at the outlet of the spacer frame assembly station 40. In the station 50, a butyl sealing bead 6 is deposited by extrusion on the side wall 53 of the spacer frame 5.

In a step g′), the outer glass sheet 1 is placed on hold in the press 80, and the outer glass sheet 3 is in the pre-fitting station 60, with its main face \textcircled{5} provided with the sealing bead 6 oriented in the direction that it had in the glass sheet butyl-coating station 30. In the pre-fitting station 60, the outer glass sheet 3 is attached to the spacer frame 5 by pre-pressing of its main face \textcircled{5} provided with the sealing bead 6 against the side wall 55 of the spacer frame, which is assembled around the central glass sheet 2′.

In a step h′), the pre-pressed assembly comprising the outer glass sheet 3 and the spacer frame 5, itself assembled around the central glass sheet 2′, passes into the press 80 where the outer glass sheet 1 is attached to the spacer frame 5 by pressing of its main face \textcircled{2} against the side wall 53 of the spacer frame provided with the sealing bead 6, and the two outer glass sheets 1, 3 are pressed on either side of the spacer frame 5.

As above, the filling of the cavities 8 and 9 may also take place in the press 80, and the triple glazing unit then passes into a sealing station 90 in which an external sealing barrier 7 made of polysulfide resin is applied over the entire outer perimeter of the spacer frame 5 between the outer glass sheets 1, 3.

In the first and second embodiments described above with reference to FIGS. 5 and 6, the movement of the central glass sheet 2′ and of the spacer frame 5 through the spacer frame assembly station 40 and through the spacer frame butyl-coating station 50 located outside of the main line may be carried out, in particular, with the aid of a second conveyor belt or a robot gripper.

As it emerges from the preceding examples, the process according to the invention has the advantage of preventing degradations of the sealing beads, by proposing to deposit them preferentially on the glass sheets rather than on the spacer frame. This is because the glass sheets, which are in general moved on a conveyor belt, are subjected to few handling operations, or even no handling operations, capable of damaging the sealing beads.

In the first embodiment described with reference to FIG. 5, the only handling operation of the glass sheets provided with a sealing bead is the turning over of a glass sheet, which may be carried out easily without touching the main face provided with the sealing bead, for example with the aid of suction pads that act on the opposite main face of the glass sheet. In the second embodiment described with reference to FIG. 6, the glass sheets provided with a sealing bead are not subjected to any handling operation between the step of depositing the sealing bead and the step of fitting the glass sheet to the spacer frame.

Furthermore, as the deposition of the sealing bead on the or each glass sheet is carried out on the main multiple glazing unit production line, upstream of the station for fitting the glass sheets provided with a sealing bead to the spacer frame, the assembling of each glass sheet with the spacer frame may take place rapidly, while the sealing bead is still hot. This helps to create an effective, good-quality primary barrier seal between the spacer frame and each glass sheet.

Advantageously, as illustrated in the preceding examples, the process according to the invention may be carried out in a completely automated manner. Furthermore, the various glass sheets of the multiple glazing unit may be received simultaneously in various work stations. These two aspects make it possible to increase the productivity and decrease the production costs of multiple glazing units.

The invention is not limited to the examples described and represented.

In particular, the process according to the invention may be carried out in a completely automated manner, or in a partially automated manner, or even without automation.

Furthermore, the process according to the invention may operate with a grouped treatment of a batch of glass sheets (batch treatment) for various steps of the process, followed by an assembling of several multiple glazing units from the batch of glass sheets thus prepared, rather than operating by the sequence for manufacturing a multiple glazing unit as described with reference to FIGS. 5 and 6. In particular, the deposition of sealing beads on a peripheral portion of a main face of the glass sheets may be carried out in a grouped manner for a batch of glass sheets (batch butyl coating) and followed by an assembling of several multiple glazing units by attaching the batch of glass sheets prepared to spacer frames (batch assembly). In this case, the glass sheets are preferably in an essentially horizontal, rather than vertical, position in the various work stations of the plant for manufacturing multiple glazing units.

1. A process for manufacturing a multiple glazing unit comprising at least three glass sheets and a spacer frame fastened between two outer glass sheets of the at least three glass sheets, each central glass sheet of the multiple glazing unit being received in an internal peripheral groove of the spacer frame, each of the two outer glass sheets being connected to a side wall of the spacer frame by means of a sealing bead, the process comprising:
for at least one glass sheet of the two outer glass sheets, depositing a sealing bead on a peripheral portion of a main face of the at least one glass sheet;
assembling the spacer frame around the central glass sheet(s);
attaching each outer glass sheet provided with its sealing bead to a side wall of the spacer frame.

2. The process as claimed in claim 1, further comprising:
for each of the two outer glass sheets, depositing a sealing bead on a peripheral portion of a main face of the glass sheet;
attaching each outer glass sheet provided with its sealing bead to a side wall of the spacer frame.

3. The process as claimed in claim 1, further comprising:
depositing a sealing bead on a peripheral portion of a main face of a first outer glass sheet, which is intended to be connected to a first side wall of the spacer frame;
depositing a sealing bead on a second side wall of the spacer frame opposite the first side wall of the spacer frame;
attaching the first outer glass sheet provided with its sealing bead to the first side wall of the spacer frame;
attaching the second outer glass sheet to the second side wall of the spacer frame provided with its sealing bead.

4. A process for manufacturing a multiple glazing unit comprising at least one spacer frame fastened between a first and a second glass sheets, each of the first and second glass sheets being connected to a side wall of the spacer frame by means of a sealing bead, the spacer comprising:
depositing a sealing bead on a peripheral portion of a main face of the first glass sheet, which is intended to be connected to a first side wall of the spacer frame;
depositing a sealing bead on a second side wall of the spacer frame opposite the first side wall of the spacer frame;
attaching the first glass sheet provided with its sealing bead to the first side wall of the spacer frame;
attaching the second glass sheet to the second side wall of the spacer frame provided with its sealing bead.

5. The process as claimed in claim 1, wherein the assembling of the spacer frame of the multiple glazing unit and the deposition of a sealing bead on at least one glass sheet of the multiple glazing unit take place simultaneously in two separate stations.

6. The process as claimed in claim 1, wherein each sealing bead is based on a resin selected from: polyisobutylene (butyl); a hot-melt adhesive; an acrylic or rubber- or silicone-modified acrylic double-sided adhesive tape, of pressure-sensitive adhesive (PSA) type; an adhesive of acrylic or epoxy type.

7. The process as claimed in claim 1, wherein for each glass sheet intended to be provided with a sealing bead, the sealing bead is deposited on a peripheral portion of a main face of the glass sheet by extrusion.

8. The process as claimed in claim 4, wherein each of the first and second glass sheets is attached to a side wall of the spacer frame by pressing.

9. The process as claimed in claim 1, wherein each glass sheet of the multiple glazing unit is moved through several successive work stations while being substantially vertical.

10. The process as claimed in claim 1, wherein at least one glass sheet intended to be connected to a side wall of a spacer frame of the multiple glazing unit passes through several successive stations that comprise at least, from upstream to downstream:
a station for washing the glass sheet;
a station for depositing a sealing bead on a peripheral portion of a main face of the glass sheet;
a station for fitting the glass sheet to the spacer frame.

11. The process as claimed in claim 10, wherein the glass sheet is moved through the successive work stations using a conveyor belt.

12. The process as claimed in claim 10, wherein, prior to passing through the station for fitting the glass sheet to the spacer frame, the glass sheet passes through a station for turning the glass sheet through 180° so as to reverse the direction of its main faces.

13. A plant for manufacturing multiple glazing units comprising at least one spacer frame fastened between two glass sheets, comprising, at the same time, an assembling station for assembling a spacer frame, and a bead deposition station, which is different from the assembling station, for depositing a sealing bead on a peripheral portion of a main face of a glass sheet, so that the assembling of the spacer frame of a multiple glazing unit and the deposition of a sealing bead on at least one glass sheet of the same multiple glazing unit may take place simultaneously in the assembling station and in the bead deposition station.

14. The plant as claimed in claim 13, wherein the plant is constructed and arranged to manufacture multiple glazing units comprising at least three glass sheets and a spacer frame fastened between two outer glass sheets of the at least three glass sheets, each central glass sheet of the multiple glazing unit being received in an internal peripheral groove of the spacer frame, and wherein:
the assembling station is configured to ensure an assembling of the spacer frame around the central glass sheet(s),
the bead deposition station is configured to ensure a deposition of a sealing bead on a peripheral portion of a main face of at least one of the two outer glass sheets.

15. The plant as claimed in claim 13, comprising a main line with several successive stations comprising, from upstream to downstream:
a station for washing glass sheets;
the bead deposition station for depositing a sealing bead on a peripheral portion of a main face of a glass sheet;
a station for fitting glass sheets to a spacer frame.

16. The plant as claimed in claim 15, wherein the main line comprises, between the bead deposition station for depositing a sealing bead on a glass sheet and the station for fitting glass sheets to a spacer frame, a station for turning a glass sheet through 180° so as to reverse the direction of its main faces.

17. The plant as claimed in claim 15, comprising a conveyor belt for moving the glass sheets through the successive stations of the main line.

18. The plant as claimed in claim 15, wherein the station for assembling a spacer frame, and an optional station for depositing a sealing bead on a side wall of a spacer frame, are located outside of the main line and upstream of the station for fitting glass sheets to a spacer frame.
